(19) United States
(12) Patent Application Publication
(10) Pub. No.: US 2008/0185553 A1
(43) Pub. Date: Aug. 7, 2008

(54) Aqueous Dispersions of Water Soluble or Swellable Polymers as Extinguishing Agents and Method for Fighting Fires

(75) Inventors: Antje Ziemer, Mannheim (DE); Pulakesh Mukherjee, Mannheim (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 11/913,581

(22) PCT Filed: May 17, 2006
(86) PCT No.: PCT/EP2006/062378

§ 371 Date: Nov. 5, 2007

(30) Foreign Application Priority Data
May 19, 2005 (DE) 10 2005 023 800.9

(51) Int. Cl. A62D 1/00

(52) U.S. Cl. 252/8.05

(57) ABSTRACT

Use of aqueous dispersions of water-soluble and/or water-swellable anionic polymers and water-soluble neutralizing agents as an additive to aqueous extinguishing agents, and method for fighting fires with aqueous extinguishing agents, an aqueous dispersion of water-soluble and/or water-swellable anionic polymers and at least one water-soluble neutralizing agent being mixed with water so that the mixture has a polymer content of not more than 5% by weight and a pH of at least 5.5.

The invention relates to the use of aqueous dispersions of water-soluble and/or water-swellable polymers in extinguishing agents and a method for fighting fires with aqueous extinguishing agents which comprise at least one polymer.

U.S. Pat. No. 3,229,769 discloses that, for example, the spread of fire in forests can be suppressed or prevented by covering those areas of inflammable materials which border a fire with a finely divided coating material which comprises crosslinked polymers swollen in water as a substantial component. The polymers have a high water absorptivity, for example up to 1040 g of water per g of polymer. They are present in the extinguishing agent in an amount of from 0.01 to 5% by weight. Suitable polymers are, for example, crosslinked polyacrylamides or alkali metal or ammonium salts of crosslinked polyacrylic acids.

U.S. Pat. No. 3,976,580 discloses the use of an aqueous gel of polyacrylamide and bentonite for fighting fire. The mixture can be stored, for example, in the form of a dry powder and, when used as a fire extinguishing agent, can be metered in a water stream, for example in a fire extinguishing hose, and can be used together with the extinguishing water for fire fighting.

EP-A 649 669 discloses an extinguishing agent which can be used both as a dry extinguishing agent and as an extinguishing additive in water. The extinguishing agent substantially comprises pulverulent, hydrogel-forming polymers and at least one substance having a large surface structure and/or capillary and/or fibrous structure. The extinguishing agent can, if appropriate, comprise an adhesive in order to improve the adhesion of the hydrogels to the source of the fire.

Further methods and apparatuses for fire fighting using superabsorbent polymers and water are disclosed in U.S. Pat. No. 5,849,210 and U.S. Pat. No. 6,786,286.

With the use of hydrogels, such as, in particular, superabsorbent polymers (SAP), for fire fighting, there is the danger that the hydrogels will agglomerate and thus lead to problems during fire fighting. In the extreme case, the fire fighting apparatus may even become inoperable. Furthermore, handling of the systems is limited. As a result of using small amounts of hydrogel, there is a sharp increase in viscosity, which can no longer be handled. The preparation of the mixture of swollen SAP is likewise difficult.

It is the object of the invention to provide, for fighting fires which can be extinguished with water, an agent which increases the viscosity of water and/or slows down the evaporation of water and results in virtually no agglomeration, has a long shelf-life and is easy to handle.

The object is achieved, according to the invention, by the use of aqueous dispersions of water-soluble and/or water-swellable anionic polymers and water-soluble neutralizing agents as an additive to aqueous extinguishing agents.

An aqueous extinguishing agent is to be understood primarily as meaning water, which, if appropriate, may additionally comprise at least one flameproofing agent, one dye and/or one wetting agent. Suitable flameproofing agents are, for example, ammonium polyphosphate, polybrominated biphenyls (PBB), polybrominated diphenyl ethers (PBDE), tetrabromobisphenol A (TBBA), chloroparaffins and antimony trioxide, alkali metal silicates and borates, urea mixtures, dicyandiamide and organic phosphates. Suitable wetting agents are all surface-active substances, such as ethoxylated alcohols having at least 12 carbon atoms in the molecule, ethoxylated phenols and/or ethoxylated polyols, such as glycerol or polyethylene glycols.

The preparation of the extinguishing agents can be effected batchwise by a batch method or continuously. For example, an aqueous dispersion of a water-soluble and/or water-swellable anionic polymer is diluted with water to a polymer concentration of not more than 5% by weight, and the aqueous solution formed is adjusted to a pH of at least 5.5 by adding at least one water-soluble neutralizing agent. Preferably, the aqueous polymer dispersion is diluted by introducing it simultaneously but separately from the feed point of the polymer dispersion with the neutralizing agent into water and stirring the resulting mixture. The neutralizing agent can, however, also be initially taken in the water used for the dilution or can be metered after addition of the polymer dispersion. However, the polymer dispersion can, for example, be continuously diluted with water in a mixing chamber or in a multimaterial nozzle under the action of a shear field and at the same time at least one water-soluble neutralizing agent can be added. The pH of the aqueous extinguishing agent is preferably in the range from 6 to 13, in particular from 7 to 12.

The polymer concentration of the aqueous extinguishing agent is in general from 0.01 to 2.5% by weight. It is preferably in the range from 0.1 to 2.0% by weight. These extinguishing agents have, for example, a viscosity of from at least 1000 mPa·s to 100 000 mPa·s, the viscosity of the extinguishing agents is in general above 3000 mPa·s, preferably above 5000 mPa·s and in particular above 10 000 mPa·s. The viscosity data relate to the measurement using a Brookfield R/S rheometer, spindle V40203T01, at 20 rpm and a temperature of 23° C.

For example, compared with extinguishing agents which comprise a superabsorber, the aqueous extinguishing agents to be used according to the invention have the advantage that they can be stored for a longer time—even at relatively high temperatures, e.g. 80° C.—without a viscosity decrease which is measurable in practice. The extinguishing agents according to the invention are pumpable. They can therefore be pumped from a storage container, for example in the vicinity of a source of a fire, and be sprayed onto the material to be extinguished. Another possibility for use is to spray the extinguishing agents according to the invention from a pressurized container which is under a nitrogen pressure of, for example, 10 bar, via a valve onto burning material in order to extinguish the fire.

The invention also relates to a method for fighting fires with aqueous extinguishing agents which comprise at least one polymer, an aqueous dispersion of water-soluble and/or water-swellable anionic polymers and at least one water-soluble neutralizing agent being mixed in each case continuously with water so that the mixture has a polymer content of not more than 5% by weight and a pH of at least 5.5, and said mixture is used immediately for fire fighting.

The method for fighting fires with aqueous extinguishing agents which comprise at least one polymer can also be carried out batchwise by using, for fire fighting, an aqueous mixture which is obtainable by batchwise mixing of an aqueous dispersion of water-soluble and/or water-swellable anionic polymers and at least one water-soluble neutralizing agent with water, the polymer content of the mixture being not more than 5, preferably not more than 2.5, % by weight and the pH being at least 5.5, preferably at least 7.5.

Aqueous dispersions of water-soluble and/or water-swellable anionic polymers are known, cf. for example U.S. Pat. No. 4,380,600; EP-A 183 466; U.S. Pat. No. 5,605,970; WO 97/34933 and DE-A 103 38 828. Such dispersions are obtainable, for example, by polymerizing water-soluble anionic monomers from the group consisting of the ethylenically unsaturated C₃— to C₅-carboxylic acids, vinyisulfonic acid, styrenesulfonic acid, acrylamidomethylpropanesulfonic acid, vinyisulfonic acid and/or the alkali metal or ammonium salts thereof in an aqueous solution which comprises at least one other polymer and, if appropriate, at least one neutral salt as a stabilizer for the polymer dispersion formed.

Aqueous dispersions of water-soluble and/or water-swellable anionic polymers which are obtainable by polymerization of water-soluble anionic monomers in an aqueous solution which is free of neutral salts and comprises, as a stabilizer, at least one other water-soluble polymer from the group consisting of the polyethylene glycols, polypropylene glycols, polyvinyl acetates, polyvinyl alcohols, polyvinylimidazoles, water-soluble starches, thermally, oxidatively or enzymatically degraded starches, cationically or anionically modified starches, maltodextrin and polydiallyidimethylammonium chloride are preferred.

Particularly suitable are the aqueous dispersions of water-soluble and/or water-swellable anionic polymers, which dispersions are disclosed in DE-A 103 38 828 and are obtainable by polymerization of water-soluble anionic monomers in an aqueous solution which is free of neutral salts and comprises, as a stabilizer, at least one water-soluble polymer from the groups consisting of
(a) graft polymers of vinyl acetate and/or vinyl propionate on polyethylene glycols, polyethylene glycols endcapped at one or both ends with alkyl, carboxyl or amino groups, copolymers of alkylpolyalkylene glycol acrylates or alkylpolyalkylene glycol methacrylates and acrylic acid and/or methacrylic acid, polyalkylene glycols having molar masses M_{N} of from 1000 to 100 000, and polyalkylene glycols endcapped at one or both ends with alkyl, carboxyl or amino groups and having molar masses M_{N} of from 1000 to 100 000 and
(b) hydrolyzed copolymers of vinyl alkyl ethers and maleic anhydride in the form of the free carboxyl groups and in the form of the salts at least partly neutralized with alkali metal hydroxides or ammonium bases and/or a water-soluble starch with a group consisting of cationically modified potato starch, anionically modified potato starch, degraded potato starch and maltodextrin.

According to the invention, those aqueous dispersions of water-soluble and/or water-swellable anionic polymers which are obtainable by polymerization of water-soluble anionic monomers in an aqueous solution which is free of neutral salts and comprises, as a stabilizer, at least one water-soluble polymer from the group consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, and polyalkylene glycols endcapped at one or both ends with alkyl, carboxyl or amino groups and
(b) water-soluble copolymers of
(b1) nonionic monoethylenically unsaturated monomers,
(b2) cationic monoethylenically unsaturated monomers and, if appropriate,
(b3) anionic monoethylenically unsaturated monomers, the proportion of the cationic monomers incorporated in the form of polymerized units being greater than that of the anionic monomers
   are also preferably used.

The preferably used aqueous dispersions of water-soluble and/or water-swellable anionic polymers also include dispersions which by polymerization of water-soluble anionic monomers in an aqueous solution which is free of neutral salts and comprises, as a stabilizer, at least one water-soluble polymer from the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, and polyalkylene glycols endcapped at one or both ends with alkyl, carboxyl or amino groups and
(b) (i) homo- and copolymers of anionic monomers,
   (ii) copolymers of anionic and cationic and, if appropriate, neutral monomers, the proportion of the anionic monomers incorporated in the form of polymerized units being greater than that of the cationic monomers, and
   (iii) copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate.

Suitable ethylenically unsaturated, anionic monomers are, for example, monoethylenically unsaturated C₃— to C₅-carboxylic acids, such as acrylic acid, methacrylic acid, ethacrylic acid, crotonic acid, maleic acid, fumaric acid, vinylsulfonic acid, styrenesulfonic acid, acrylamidomethylpropanesulfonic acid, vinylphosphonic acid, itaconic acid and/or the alkali metal or ammonium salts of these acids. The preferably used anionic monomers include acrylic acid, methacrylic acid, maleic acid and acrylamido-2-methylpropanesulfonic acid. Aqueous dispersions of polymers based on acrylic acid are particularly preferred. The anionic monomers can be polymerized either alone to give homopolymers or as a mixture with one another to give copolymers. Examples of these are the homopolymers of acrylic acid or copolymers of acrylic acid with methacrylic acid and/or maleic acid.

The polymerization of the anionic monomers can, however, also be carried out in the presence of other ethylenically unsaturated monomers. These monomers may be nonionic or may carry a cationic charge. Examples of such comonomers are acrylamide, methacrylamide, acrylates of monohydric alcohols having 1 to 20 carbon atoms, methacrylates of monohydric alcohols having 1 to 20 carbon atoms, vinyl acetate, vinyl propionate, dialkylaminoethyl(meth)acrylates, dialkylaminopropyl(meth)acrylates, diallyldlimethylammonium chloride, N-vinylformamide, vinylimidazole and quaternized vinylimidazole. Basic monomers, such as dialkylaminoalkyl (meth)acrylates, e.g. dimethylaminoethyl acrylate or dimethylaminoethyl methacrylate, can be used in the polymerization both in the form of the free bases and in partly or completely neutralized form or in a form quaternized, for example, with C₁— to C₁₈-alkyl halides. The comonomers are used in the preparation of the anionic polymers, for example, in amounts such that the resulting polymers are water-soluble and have an anionic charge. Based on the monomers used altogether in the polymerization, the amount of nonionic and/or cationic comonomers is, for example, from 0 to 99, preferably from 5 to 75, % by weight.

Preferred copolymers are, for example, copolymers of from 25 to 90% by weight of acrylic acid and from 75 to 10% by weight of acrylamide. Particularly preferred are homopolymers of acrylic acid which are obtainable by free radical polymerization of acrylic acid in the absence of other monomers, and copolymers of acrylic acid and/or methacrylic acid which can be prepared by copolymerization of acrylic acid and/or methacrylic acid in the presence of pentaerythrityl triallyl ether, N,N′-divinylethyleneurea, those allyl ethers of sugars which comprise at least two allyl groups, such as sucrose, glucose or mannose, or triallylamine and mixtures of these compounds.

The polymerization can be carried out additionally in the presence of at least one crosslinking agent. Copolymers having a higher molar mass than in the case of polymerization of the anionic monomers in the absence of a crosslinking agent are then obtained. The incorporation of a crosslinking agent into the polymers also leads to a lower solubility of the polymers in water. Depending on the amount of crosslinking agent incorporated in the form of polymerized units, the polymers become water-insoluble but are swellable in water. There are fluid transitions between complete solubility of the polymers in water and the swelling of the polymers in water. Owing to their swellability in water, crosslinked copolymers have a high water absorptivity.

Crosslinking agents which may be used are all compounds which have at least two ethylenically unsaturated double bonds in the molecule. Such compounds are used, for example, in the preparation of crosslinked polyacrylic acids, such as superabsorbent polymers, cf. EP-A 858 478, page 4, line 30 to page 5, line 43. Examples of crosslinking agents are triallylamine, pentaerythrityl triallyl ether, methylene-bisacrylamide, N,N′-divinylethyleneurea, allyl ethers comprising at least two allyl groups, or vinyl ethers comprising at least two vinyl groups, of polyhydric alcohols, such as, for example, sorbitol, 1,2-ethanediol, 1,4-butanediol, trimethylolpropane, glycerol or diethylene glycol, and of sugars, such as sucrose, glucose or mannose, dihydric alcohols completely esterified with acrylic acid or methacrylic acid and having 2 to 4 carbon atoms, such as ethylene glycol dimethacrylate, ethylene glycol diacrylate, butanediol dimethacrylate, butanediol diacrylate, diacrylates or dimethacrylates of polyethylene glycols having molecular weights of from 300 to 600, ethoxylated trimethylenepropane triacrylates or ethoxylated trimethylenepropane trimethacrylates, 2,2-bis(hydroxymethyl)butanol trimethacrylate, pentaerythrityl triacrylate, pentaerythrityl tetraacrylate and triallylmethylammonium chloride. If crosslinking agents are used in the preparation of the anionic dispersions, the amounts of crosslinking agents used in each case are, for example, from 0.0005 to 5.0, preferably from 0.001 to 1.0, % by weight, based on the monomers used altogether in the polymerization. Preferably used crosslinking agents are pentaerythrityl triallyl ether, N,N′-divinylethyleneurea, allyl ethers, comprising at least two allyl groups of sugars such as sucrose, glucose or mannose, and triallylamine and mixtures of these compounds.

The polymerization can additionally be carried out in the presence of at least one chain transfer agent. Polymers which have a lower molar mass and polymers prepared without chain transfer agents are then obtained. Examples of chain transfer agents are compounds which comprise sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, organic acids, such as formic acid, sodium formate or ammonium formate, alcohols, such as, in particular, isopropanol, and phosphorus compounds, e.g. sodium hypophosphite. It is possible to use a single chain transfer agent or a plurality of chain transfer agents in the polymerization. If they are used in the polymerization, they are employed, for example, in an amount of from 0.01 to 5.0, preferably from 0.2 to 1, % by weight, based on the total monomers. The chain transfer agents are preferably used together with at least one crosslinking agent in the polymerization. By varying the amount and the ratio of chain transfer agent and crosslinking agent, it is possible to control the rheology of the polymers formed. Chain transfer agents and/or crosslinking agents can be initially taken in the polymerization, for example in the aqueous polymerization medium, or can be metered into the polymerization batch together with or separately from the monomers, according to the progress of the polymerization.

Initiators which form free radicals under the reaction conditions are usually used in the polymerization. Suitable polymerization initiators are, for example, peroxides, hydroperoxides, hydrogen peroxide, sodium or potassium persulfate, redox catalysts and azo compounds, such as 2,2-azobis(N,N-dimethyleneisobutyramidine) dihydrochloride, 2,2-azobis(4-methoxy-2,4-dimethylvaleronitrile), 2,2-azobis(2,4-dimethylvaleronitrile) and 2,2-azobis(2-amidinopropane) dihydrochloride. The initiators are used in the amounts customary in the polymerization. Azo initiators are preferably used as polymerization initiators. However, the polymerization can also be initiated with the aid of high-energy radiation, such as electron beams, or by exposure to UV light.

The aqueous dispersions of the water-soluble anionic polymers have a polymer concentration of anionic polymers of, for example, from 1 to 70% by weight, in general from 5 to 50, preferably from 10 to 25 and particularly preferably from 15 to 20% by weight. They comprise at least two different groups of the abovementioned polymers (a) and (b) for stabilizing the anionic polymers formed in the polymerization. The amount of stabilizers (a) and (b) in the aqueous dispersion is, for example, from 1 to 40% by weight, in general from 5 to 30% by weight and preferably from 10 to 25% by weight. The aqueous dispersions have, for example, at a pH of 2.5, viscosities in the range from 200 to 100 000 mPa·s, preferably from 200 to 20 000 mPa·s, preferably from 200 to 10 000 mPa·s (measured in a Brookfield viscometer at 20° C., spindle 6, 100 rpm).

The stabilizers of group (a) include graft polymers of vinyl acetate and/or vinyl propionate on (i) polyethylene glycols or (ii) polyethylene glycols or polypropylene glycols endcapped at one or both ends with alkyl, carboxyl or amino groups, and also polyalkylene glycols and polyalkylene glycols endcapped at one or both ends with alkyl, carboxyl or amino groups.

Polyalkylene glycols are described, for example, in WO 03/046024, page 4, line 37 to page 8, line 9. The polyalkylene glycols described therein can be used either directly as a stabilizer of group (a) or can be modified so that, for example, from 10 to 1000, preferably from 30 to 300, parts by weight of vinyl acetate and/or vinyl propionate are grafted onto 100 parts by weight of the polyalkylene glycols. Preferably, polyethylene glycol having a molecular weight M_{N} of from 1000 to 100 000 is used as the grafting base and vinyl acetate is grafted thereon.

Further suitable stabilizers (a) are the abovementioned polyalkylene glycols and polyalkylene glycols endcapped at one or both ends with alkyl, carboxyl or amino groups. The abovementioned polymers have, for example, molar masses M_{N} of from 100 to 100 000, preferably from 300 to 80 000, particularly preferably from 600 to 50 000 and in particular from 1000 to 50 000. Such polymers are described, for example, in the above-cited WO 03/046024, page 4, line 37 to page 8, line 9. Preferred polyalkylene glycols are, for example, polyethylene glycol, polypropylene glycol and block copolymers of ethylene oxide and propylene oxide. The block copolymers may comprise, incorporated in the form of polymerized units, ethylene oxide and propylene oxide in any desired amounts and in any desired sequence. The terminal OH groups of the polyalkylene glycols can, if appropriate, be endcapped at one or both ends with alkyl, carboxyl or amino groups, a methyl group being preferred as a terminal group.

Particularly preferably used stabilizers of group (a) are copolymers of ethylene oxide and propylene oxide. Particularly preferred are block copolymers of ethylene oxide and propylene oxide having a molar mass M_{N} of from 500 to 20 000 g/mol and a content of ethylene oxide units of from 10 to 80 mol %.

The water-soluble polymers of group (a) are used, for example, in amounts of from 1 to 39.5% by weight, preferably from 5 to 30% by weight and particularly preferably from 10 to 25% by weight, based on the total dispersion, in the preparation of the dispersion.

Water-soluble copolymers of
(b1) water-soluble, nonionic, monoethylenically unsaturated monomers,
(b2) water-soluble, cationic, monoethylenically unsaturated monomers and, if appropriate,
(b3) water-soluble, anionic, monoethylenically unsaturated monomers are used as polymers of group (b), the proportion of the cationic monomers incorporated in the form of polymerized units being greater than that of the anionic monomers.

Examples of water-soluble, nonionic monomers (b1) are acrylamide, methacrylamide, N-vinylformamide, N-vinylpyrrolidone and N-vinylcaprolactam. In principle, all nonionic, monoethylenically unsaturated monomers which have a water solubility of at least 100 g/l at a temperature of 20° C. are suitable as monomers of group (b1). Monomers (b1) which are miscible with water in any ratio and form clear aqueous solutions, such as acrylamide or N-vinylformamide, are particularly suitable.

Water-soluble, cationic, monoethylenically unsaturated monomers (b2) are, for example, dialkylaminoalkyl(meth)acrylates, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate and diethylaminopropyl methacrylate, dialkyldiallylammonium halides, such as dimethyidiallylammonium chloride and diethyidiallylammonium chloride, N-vinylimidazole and quaternized N-vinylimidazole. Basic monomers, such as dimethylaminoethyl acrylate or dimethylaminoethyl methacrylate, can be used both in the form of the free bases and in the form of partly or completely neutralized with acids, such as hydrochloric acid, sulfuric acid, formic acid and p-toluenesulfonic acid. The basic monomers can also be partly or completely quaternized with C₁— to C₁₈-alkyl halides and/or C₁— to C₁₈-alkyl C₁-C₁₈-alkylaryl halides and can be used in this form in the polymerization. Examples of these are the dimethylaminoethyl(meth)acrylates completely quaternized with methyl chloride, such as dimethylaminoethyl acrylate methochloride or dimethylaminoethyl methacrylate methochloride. The polymers of group (b) may also comprise vinylamine units as cationic groups. Such polymers are obtainable, for example, by polymerizing N-vinylformamide, if appropriate together with at least one anionic water-soluble monomer, and then hydrolyzing the polymers with partial elimination of formyl groups to give polymers comprising vinylamine units.

The polymers of group (b) can, if appropriate, also comprise at least one anionic, monoethylenically unsaturated monomer (b3) incorporated in the form of polymerized units. Examples of such monomers are the abovementioned anionic monomers which form water-soluble polymers, such as acrylic acid, methacrylic acid, vinylsulfonic acid, vinylphosphonic acid, maleic acid, fumaric acid, crotonic acid, itaconic acid and the alkali metal and ammonium salts of these acids.

Examples of copolymers of group (b) are water-soluble copolymers of
(b1) acrylamide, methacrylamide, N-vinylformamide, N-vinylpyrrolidone and/or N-vinylcaprolactam,
(b2) dialkylaminoalkyl acrylate, dialkylaminoalkyl methacrylate, partly or completely neutralized dialkylaminoalkyl(meth)acrylates, quaternized dialkylaminoalkyl(meth)acrylates, dialkyldiallylammonium halides, N-vinylimidazole and quaternized N-vinylimidazole and, if appropriate,
(b3) acrylic acid, methacrylic acid, vinylsulfonic acid, vinylphosphonic acid, maleic acid, fumaric acid, crotonic acid, itaconic acid and the alkali metal and ammonium salts of these acids.

The water-soluble polymers (b) comprise, for example,
(b1) from 2 to 90, preferably from 20 to 80 and particularly preferably from 35 to 70 mol % of at least one nonionic monomer
(b2) from 2 to 90, preferably from 20 to 80 and particularly preferably from 35 to 70 mol % of at least one cationic monomer and
(b3) from 0 to 48.9 mol %, preferably from 0 to 30 and particularly preferably from 0 to 10 mol %, of at least one anionic monomer incorporated in the form of polymerized units, the proportion of the cationic monomer units being greater than that of the anionic monomer units.

Specific examples of polymers (b) are copolymers of acrylamide and dimethylaminoethyl acrylate methochloride, copolymers of acrylamide and dimethylaminoethyl methacrylate methochloride, copolymers of acrylamide and dimethylaminopropyl acrylate methochloride, copolymers of methacrylamide and dimethylaminoethyl methacrylate methochloride, copolymers of acrylamide, dimethylaminoethyl acrylate methochloride and acrylic acid, copolymers of acrylamide, dimethylaminoethyl methacrylate methochloride and methacrylic acid and copolymers of acrylamide, dimethylaminoethyl acrylate methochloride and acrylic acid.

The polymers (b) have, for example, a K value of from 15 to 200, preferably from 30 to 150, particularly preferably from 45 to 110 (determined according to H. Fikentscher, Cellulose-Chemie, Volume 13, 58-64 and 71-74 (1932) in 3% strength by weight aqueous sodium chloride solution at 25° C., a polymer concentration of 0.1% by weight and a pH of 7). The average molar mass of the anionic polymers suitable as component (b) of the stabilizer mixture is, for example, up to 1.5 million, in general up to 1 million and preferably in the range from 1000 to 100 000 (determined by the light scattering method).

The aqueous dispersions comprise the polymers of group (b), for example, in amounts of from 0.5 to 15, preferably from 1 to 10, % by weight.

The aqueous dispersions of the anionic polymers preferably comprise, as a stabilizer, a combination of
(a) at least one block copolymer of ethylene oxide and propylene oxide and
(b) at least one copolymer of acrylamide and dimethylaminoethyl acrylate methochloride.

The copolymer (b) can, if appropriate, also comprise up to 5 mol % of acrylic acid incorporated in the form of polymerized units.

Hydrolyzed copolymers of vinyl alkyl ethers and maleic anhydride and those salts of the copolymers which are obtainable therefrom by partial or complete neutralization with alkali metal and/or ammonium bases are also particularly suitable as component (b) of stabilizer mixtures for the preparation of aqueous dispersions of water-soluble anionic polymers. The alkyl group of the vinyl alkyl ethers may have, for example, 1 to 4 carbon atoms. The copolymers are obtainable by copolymerization of vinyl alkyl ethers with maleic anhydride and subsequent hydrolysis of the anhydride groups to carboxyl groups and, if appropriate, partial or complete neutralization of the carboxyl groups. Particularly preferred water-soluble polymers of group (b) are hydrolyzed copolymers of vinyl methyl ether and maleic anhydride in the form of the free carboxyl groups and in the form of the salts at least partly neutralized with sodium hydroxide solution, potassium hydroxide solution or ammonia.

Further suitable water-soluble polymers of group (b) are water-soluble starches from the group consisting of cationically modified potato starch, anionically modified potato starch, degraded potato starch and maltodextrin. Examples of cationically modified potato starches are the commercial products Amylofax 15 and Perlbond 970. A suitable anionically modified potato starch is Perfectamyl A 4692. Here, the modification substantially comprises carboxylation of potato starch. C*Pur 1906 is an example of an enzymatically degraded potato starch, and maltodextrin C 01915 is an example of a hydrolytically degraded potato starch. Of said starches, maltodextrin is preferably used.

Further preferably used polymers of component (b) of the stabilizer mixtures are homo- and copolymers having molar masses M_{w} of up to 100 000 and obtained from anionic monomers, for example homopolymers of ethylenically unsaturated C₃— to C₅-carboxylic acids, such as, in particular, homopolymers of acrylic acid or methacrylic acid, or other monomers comprising acid groups, such as acrylamidomethylpropanesulfonic acid, styrenesulfonic acid, sulfoethyl acrylate, sulfoethyl methacrylate, vinyisulfonic acid and vinylphosphonic acid, and the alkali metal and ammonium salts of the monomers comprising acid groups. Said anionic monomers may be partly or completely neutralized. Copolymers of anionic monomers are also suitable as component (b) of the stabilizer mixtures, for example copolymers of acrylic acid and methacrylic acid, copolymers of acrylic acid and maleic acid, copolymers of methacrylic acid and maleic acid and copolymers of acrylic acid and itaconic acid.

Further suitable polymers which are used as component (b) of the stabilizer mixtures are copolymers of (i) anionic and (ii) cationic and, if appropriate, (iii) neutral monomers, the proportion of the anionic monomers incorporated in the form of polymerized units being greater than that of the cationic monomers. The monomers mentioned in the above paragraph can be used as (i) anionic monomers. Acrylic acid, methacrylic acid, maleic acid and acrylamidomethylpropanesulfonic acid are particularly preferred.

Examples of (ii) cationic monomers are water-soluble, cationic, monoethylenically unsaturated monomers which have already been mentioned above in the case of the stabilizers (b) under (b2) and which carry a cationic charge, e.g. dialkylaminoalkyl (meth)acrylates in the form of the salts with acids or in quaternized form, dialkyldiallylammonium halides, such as dimethyidiallylammonium chloride and diethyidiallylammonium chloride, and quaternized N-vinylimidazole.

Examples of (iii) neutral monomers are all esters of anionic monomers with monohydric C₁— to C₁₈-alcohols, styrene, N-vinylpyrrolidone, N-vinylimidazole, N-vinylformamide, acrylamide, methacrylamide, acrylonitrile, methacrylonitrile, vinyl acetate and vinyl propionate.

Further polymers suitable as component (b) of stabilizer mixtures are copolymers of (i) at least one anionic monomer (such monomers have already been mentioned above by way of example) and (ii) at least one neutral monomer from the group consisting of the esters of anionic monomers with monohydric alcohols, styrene, N-vinylpyrrolidone, N-vinylimidazole, N-vinylformamide, acrylamide, methacrylamide, acrylonitrile, methacrylonitrile, vinyl acetate and vinyl propionate. Particularly preferred from this group (b) are copolymers of acrylic acid and methacrylic acid and copolymers of acrylic acid, acrylamidomethylpropanesulfonic acid, methyl acrylate and styrene.

The molar masses M_{w} of the abovementioned polymers are, for example, in the range from 1000 to 100 000, preferably from 1500 to 70 000 and in general from 2000 to 30 000 (determined by light scattering).

The ratio of components (a) and (b) in the stabilizer mixtures can be varied within a wide range. It may be, for example, from 50:1 to 1:10. Preferably, a ratio of (a):(b) of at least 1.5:1, in particular from 7:1 to 10:1, is chosen.

The resulting stable aqueous dispersions of water-soluble anionic polymers have, for example, a particle size of from 0.1 to 200 μm, preferably from 0.5 to 70 μm. The particle size can be determined, for example, by optical microscopy, light scattering or freeze fraction electron microscopy. The aqueous dispersions are prepared, for example, at a pH of from 0.5 to 5, preferably from 1 to 3. At a pH below 5, dispersions having a content of anionic polymers of from about 5 to 35% by weight have a relatively low viscosity.

For the use as an additive to extinguishing agents, however, a higher viscosity of the extinguishing agent is desired. On dilution of the resulting aqueous dispersions of water-soluble or water-swellable dispersions with water and in particular on partial or complete neutralization of the anionic groups of the polymers, a great increase in viscosity is achieved. For the use according to the invention as an additive to extinguishing agents, the aqueous polymer dispersion is therefore used together with at least one neutralizing agent. Suitable neutralizing agents are, for example, an alkali metal, alkaline earth metal and/or ammonium base. Particularly preferred neutralizing agents are sodium hydroxide solution, potassium hydroxide solution, ammonia, ethanolamine, diethanolamine or triethanolamine. In addition, all other amines or polyamines, such as diethylenetriamine, triethylenetetramine, polyethylenimines and/or polyvinylamines can be used as neutralizing agents.

The amount of neutralizing agent which is used depends substantially on the desired viscosity which the extinguishing medium is to have. This viscosity is dependent on the pH of the extinguishing agent, which is preferably in the range from 7.5 to 11. A preferred embodiment of the invention comprises mixing an aqueous dispersion of water-soluble and/or water-swellable anionic polymers and at least one water-soluble neutralizing agent in each case continuously with water so that the mixture, i.e. the extinguishing agent, has a polymer content of not more than 5% by weight, for example from 0.1 to 2.5% by weight, in general from 1.0 to 2.0% by weight, and a pH of at least 5.5 and a viscosity of not more than 100 000 mPa·s (Brookfield viscometer, spindle V40203T01, 20 rpm, 23° C.).

Aqueous dispersions of anionic polymers which are crosslinked are particularly preferably used. The crosslinking agent is generally used during the polymerization so that polymer particles which are crosslinked throughout are obtained. However, the crosslinking agent can also be used for surface crosslinking of the dispersed polymer particles by carrying out a postcrosslinking therewith after the main polymerization, it also being possible to carry out the main polymerization in the presence of a crosslinking agent.

Aqueous polymer dispersions to be used according to the invention may comprise, for example, the following anionic polymers and may be prepared in the presence of the stabilizer components (a) and (b) stated below. The viscosities of the aqueous dispersions of water-soluble or water-swellable polymers (referred to below as “emulsion”) which are stated in the following overview were measured in a Brookfield R/S rheometer, spindle V 40203T01, at 20 rpm and a temperature of 23° C.:
(1) polyacrylic acid crosslinked with ETMPTA (ethoxylated trimethylolpropane triacrylate), stabilizer comprising (a) graft polymer of vinyl acetate on polyethylene glycol having a molar mass M_{w} of 6000 and (b) copolymer of vinyl methyl ether and maleic acid; viscosity of the emulsion: 5350 mPa·s;
(2) polyacrylic acid crosslinked with triallylamine, stabilizer comprising (a) graft polymer of vinyl acetate on polyethylene glycol having a molar mass M_{w} of 6000 and (b) copolymer of vinyl methyl ether and maleic acid; viscosity of the emulsion: 10 250 mPa·s;
(3) copolymer of 135 parts by weight of acrylic acid and 15 parts by weight of methacrylic acid, crosslinked with 1.5 parts by weight of triallylamine, stabilizer comprising (a) graft polymer of vinyl acetate on polyethylene glycol having a molar mass M_{w} of 6000 and (b) copolymer of vinyl methyl ether and maleic acid; viscosity of the emulsion: 5800 mPa·s;
(4) copolymer of 142.5 parts by weight of acrylic acid and 7.5 parts by weight of methyl acrylate, crosslinked with 1.5 parts by weight of triallylamine, stabilizer comprising (a) graft polymer of vinyl acetate on polyethylene glycol having a molar mass M_{w} of 6000 and (b) copolymer of vinyl methyl ether and maleic acid; viscosity of the emulsion: 21 900 mPa·s;
(5) polymer of 174 parts by weight of acrylic acid and 1 part by weight of pentaerythrityl triallyl ether (70% strength by weight in water), stabilizer comprising (a) 175 g of a copolymer of 20.3 parts by weight of propylene oxide and 14.2 parts by weight of ethylene oxide and (b) 62.5 parts by weight of a 40% strength by weight aqueous solution of a copolymer of 95 parts by weight of vinylimidazole, which is quaternized with methyl chloride, and 5 parts by weight of N-vinylpyrrolidone; viscosity of the emulsion: 1 200 mPa·s;
(6) polymer of 174 parts by weight of acrylic acid and 1 part by weight of pentaerythrityl triallyl ether (70% strength by weight in water), stabilizer comprising (a) 175 g of a copolymer of 20.3 parts by weight of propylene oxide and 14.2 parts by weight of ethylene oxide and (b) 37.5 parts by weight of a 40% strength by weight aqueous solution of a copolymer of 50 parts by weight of vinylimidazole, which is quaternized with methyl chloride, and 50 parts by weight of N-vinylpyrrolidone; viscosity of the emulsion: 1 850 m Pa·s;
(7) polyacrylic acid obtainable by polymerization of 30 parts by weight of acrylic acid in the presence of a stabilizer comprising (a) 19 parts by weight of a graft polymer of vinyl acetate on polyethylene glycol having a molar mass M_{w} of 6000 and (b) 17 parts by weight of a hydrolyzed copolymer of maleic anhydride and vinyl methyl ether; viscosity of the emulsion: 5950 m Pa·s;
(8) polymer of 30 parts by weight of acrylic acid and 0.09 part by weight of triallylamine, polymerized in the presence of a stabilizer comprising (a) 19 parts by weight of a graft polymer of vinyl acetate on polyethylene glycol having a molar mass M_{w} of 6000 and (b) 17 parts by weight of a hydrolyzed copolymer of maleic anhydride and vinyl methyl ether; viscosity of the emulsion: 2700 mPa·s;
(9) homopolymer of acrylic acid obtained from 30 parts by weight of acrylic acid, polymerized in the presence of a stabilizer comprising (a) 12 parts by weight of polyethylene glycol having a molar mass M_{w} of 600 and (b) 17 parts by weight of a hydrolyzed copolymer of maleic anhydride and vinyl methyl ether; viscosity of the emulsion: 2240 m Pa·s;
(10) homopolymer of acrylic acid obtained from 30 parts by weight of acrylic acid, polymerized in the presence of a stabilizer comprising (a) 1.5 parts by weight of polyethylene glycol having a molar mass of 900, 16.5 parts by weight of polyethylene glycol having a molar mass of 600 and (b) 18 parts by weight of polyethylenimine having an M_{w} of 25 000, viscosity of the emulsion: 208 mPa·s;
(11) homopolymer of acrylic acid obtained from 30 parts by weight of acrylic acid, polymerized in the presence of a stabilizer comprising (a) ester of methylpolyethylene glycol having an average molecular weight M_{w} of 1000 and methacrylic acid, which ester is grafted with the sodium salt of methacrylic acid, and (b) 17 parts by weight of a hydrolyzed copolymer of maleic anhydride and vinyl methyl ether; viscosity of the emulsion: 3650 mPa·s;
(12) crosslinked polyacrylic acid obtained from 30 parts by weight of acrylic acid and 0.22 part by weight of pentaerythrityl triallyl ether (70% strength), polymerized in the presence of a stabilizer comprising (a) 19 parts by weight of a graft polymer of vinyl acetate on polyethylene glycol having a molar mass M_{w} of 6000 and (b) 17 parts by weight of a hydrolyzed copolymer of maleic anhydride and vinyl methyl ether; viscosity of the emulsion: 2900 mPa·s;
(13) homopolymer of acrylic acid obtained from 30 parts by weight of acrylic acid, polymerized in the presence of a stabilizer comprising (a) 19 parts by weight of a graft polymer of vinyl acetate on polyethylene glycol having a molar mass M_{w} of 6000 and (b) 18 parts by weight of maltodextrin; viscosity of the emulsion: 10 500 mPa·s;
(14) crosslinked polyacrylic acid obtained from 30 parts by weight of acrylic acid and 0.09 parts by weight of triallylamine, polymerized in the presence of a stabilizer comprising (a) 19 parts by weight of a graft polymer of vinyl acetate on polyethylene glycol having a molar mass M_{w} of 6000 and (b) 17 parts by weight of a hydrolyzed copolymer of maleic anhydride and vinyl methyl ether; viscosity of the emulsion: 3700 mPa·s;
(15) homopolymer of acrylic acid obtained from 30 parts by weight of acrylic acid, polymerized in the presence of a stabilizer comprising (a) 18 parts by weight of a butylpolyalkylene glycol copolymer, M_{w} 2000 (Pluriol A2000 PE) and (b) 18 parts by weight of polyethylenimine, M_{w} 25 000; viscosity of the emulsion: 320 mPa·s.

When used according to the invention, emulsions give clear gels which have a long shelf-life even at relatively high temperatures. During fire fighting, they adhere to perpendicular surfaces and effectively prevent excessively rapid evaporation of the extinguishing water. They are particularly suitable in extinguishing water which is applied to a source of a fire from a great height, for example from a helicopter.

The viscosities stated in the examples were measured in a Brookfield R/S rheometer, spindle V 40203T01, at 20 rpm and a temperature of 23° C.

Parts are parts by weight.

### EXAMPLES

(a) Preparation of an Aqueous Dispersion of Crosslinked Polyacrylic Acid

175 g of a copolymer of 20.3 parts of propylene oxide and 14.2 parts of ethylene oxide, 95.6 g of a 20.92% strength aqueous solution of a copolymer of 35 mol % of acrylamide and 65 mol % of dimethylaminoethyl acrylate methochloride and 513.9 g of demineralized water were initially taken in a polymerization apparatus which was equipped with a stirrer and an apparatus for working under a nitrogen atmosphere. The mixture was stirred continuously and was flooded with nitrogen, initially for 10 minutes. 174 g of acrylic acid and 1.0 g of pentaerythrityl triallyl ether (70% strength) were then metered in the course of 10 minutes. Thereafter, 0.2 g of azo initiator VA 044 [2,2′-azobis(N,N′-dimethyleneisobutyramidine)dihydrochloride] in 10 g of demineralized water was added and rinsing with 10 g of water was effected. The reaction mixture was then heated to a temperature of 40° C. while continuously passing through nitrogen and was polymerized for 5 hours at this temperature. Thereafter, 0.3 g of azo initiator VA 044 in 10 g of demineralized water was added, rinsing with 10 g of demineralized water was effected and the reaction mixture was stirred for a further 2 hours at 40° C. for postpolymerization. A white emulsion which had a viscosity of 1200 mPa·s was obtained. It is designated below by dispersion A.

(b) Neutralization and Dilution of Aqueous Dispersion Obtained According to (a)

### Example 1

10 g of the dispersion A were added to an aqueous solution of 50 g of triethanolamine in 150 g of demineralized water while stirring. A sample which was in the form of a clear solution and had a pH of 9.1 and a viscosity of 35 000 mPa·s (measured at 20 rpm) was obtained. The viscosity of this sample was 7900 mPa·s at 150 rpm under otherwise identical measuring conditions.

### Example 2

First 20 g of triethanolamine and then 10 g of dispersion A were added to 180 g of demineralized water with continuous stirring. A sample which was in the form of a clear solution and had a pH of 9.5 and a viscosity of 36 500 mPa·s (measured at 20 rpm) was obtained. The viscosity of this sample was 8700 mPa·s at 150 rpm under otherwise identical measuring conditions.

### Example 3

First 10 g of triethanolamine and then 10 g of dispersion A were added to 190 g of demineralized water with continuous stirring. An extinguishing agent which had a pH of 8.7 and a viscosity of 26 800 mPa·s (measured at 20 rpm) was obtained. The viscosity of this sample was 6800 mPa·s at 150 rpm under otherwise identical measuring conditions. Such mixtures are pumpable.

### Example 4

First 10 g of triethanolamine and then 4 g of dispersion A were added to 180 g of demineralized water with continuous stirring. An extinguishing agent which had a pH of 9.2 and a viscosity of 36 500 mPa·s (measured at 20 rpm) was obtained. The viscosity of the sample was 8700 mPa·s at 150 rpm under otherwise identical measuring conditions.

### Example 5

First 30 g of triethanolamine and then 6 g of dispersion A were added to 170 g of demineralized water with continuous stirring. A sample which was in the form of a clear solution and had a pH of 9.5 and a viscosity of 36 500 mPa·s (measured at 20 rpm) was obtained. The viscosity of this sample was 8700 mPa·s at 150 rpm under otherwise identical measuring conditions.

### Example 6

In each case samples of aqueous extinguishing agents which were prepared according to examples 4 and 5 were stored under the conditions stated in table 1 (temperatures and times), and in each case the viscosity of the stored samples was then determined. The results of the measurements are shown in table 1. They show that the extinguishing agents to be used according to the invention can be stored for a longer time without a marked decrease in viscosity.

Table 1

The viscosities shown in the table were measured with a Brookfield R/S rheometer, spindle V 40203T01, at 150 rpm and a temperature of 23° C.

Samples Obtained According to Example 4

| | |
|---|---|
| Duration of | Viscosity [mPa · s] of the sample |

| storage [h] | before storage | after storage | | |
|---|---|---|---|---|
| 0 | 3300 | | | |
| 1 | | 3378 | 4267 | 4342 |
| 24 | | 4296 | 3602 | 3020 |
| 120 | | 3178 | 2994 | 2753 |

Samples Obtained According to Example 5

| | |
|---|---|
| Duration of | Viscosity [mPa · s] of the sample |

| storage [h] | before storage | after storage | | |
|---|---|---|---|---|
| 0 | 5311 | | | |
| 1 | | 6005 | 5977 | 6190 |
| 24 | | 6234 | 5187 | 4711 |
| 120 | | 4797 | 4441 | 3336 |

1. (canceled)

2. (canceled)

3. The use according to method of claim 16 wherein the pH of the aqueous extinguishing agent is from 6 to 13.

4. The method of claim 16 wherein the pH of the aqueous extinguishing agent is from 7 to 12.

5. The method of claim 16 wherein the polymer concentration of the aqueous extinguishing agent is from 0.01 to 2.5% by weight.

6. The method of claim 16 wherein the polymer concentration of the aqueous extinguishing agent is from 0.1 to 2.0% by weight.

7. The method of claim 16 wherein the aqueous dispersion of the water-soluble and/or water-swellable anionic polymer is obtained by polymerization of water-soluble anionic monomers selected from the group consisting of ethylenically unsaturated C₃— to C₅-carboxylic acids, vinylsulfonic acid, styrenesulfonic acid, acrylamidomethylpropanesulfonic acid, vinylsulfonic acid, the alkali metal or ammonium salts thereof, and mixtures thereof, in an aqueous solution which comprises at least one other polymer and, optionally, at least one neutral salt as a stabilizer for the polymer dispersion.

8. The method of claim 16 wherein the aqueous dispersion of the water-soluble and/or water-swellable anionic polymers polymer is obtained by polymerization of water-soluble anionic monomers in an aqueous solution which is free of neutral salts, and comprises, as a stabilizer, at least one other water-soluble polymer selected from the group consisting of the polyethylene glycols, polypropylene glycols, polyvinyl acetates, polyvinyl alcohols, polyvinylimidazoles, water-soluble starches, thermally, oxidatively or enzymatically degraded starches, cationically or anionically modified starches, maltodextrin, and polydiallyldimethylammonium chloride.

9. The method of claim 16 wherein the water-soluble and/or water-swellable anionic polymer is obtainable by polymerization of water-soluble anionic monomers in an aqueous solution which is free of neutral salts and comprises, as a stabilizer, at least one water-soluble polymer selected from the groups consisting of
(a) graft polymers of vinyl acetate and/or vinyl propionate on polyethylene glycols, polyethylene glycols endcapped at one or both ends with alkyl, carboxyl or amino groups, copolymers of alkylpolyalkylene glycol acrylates or alkylpolyalkylene glycol methacrylates and acrylic acid and/or methacrylic acid, polyalkylene glycols having molar masses M_{N} of from 1000 to 100 000, and polyalkylene glycols endcapped at one or both ends with alkyl, carboxyl or amino groups and having molar masses M_{N} of from 1000 to 100 000
and
(b) hydrolyzed copolymers of vinyl alkyl ethers and maleic anhydride in the form of the free carboxyl groups and in the form of the salts at least partly neutralized with alkali metal hydroxides or ammonium bases, and/or a water-soluble starch from the group consisting of cationically modified potato starch, anionically modified potato starch, degraded potato starch and maltodextrin.

10. The method of claim 16 wherein the aqueous dispersion is obtainable by polymerization of water-soluble anionic monomers in an aqueous solution which is free of neutral salts and comprises, as a stabilizer, at least one water-soluble polymer from the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, and polyalkylene glycols endcapped at one or both ends with alkyl, carboxyl or amino groups and
(b) water-soluble copolymers of
(b1) nonionic monoethylenically unsaturated monomers,
(b2) cationic monoethylenically unsaturated monomers and, optionally,
(b3) anionic monoethylenically unsaturated monomers, a proportion of the cationic monomers incorporated in a form of polymerized units being greater than that of the anionic monomers.

11. The method of claim 16 wherein the aqueous dispersion is obtainable by polymerization of water-soluble anionic monomers in an aqueous solution which is free of neutral salts and comprises, as a stabilizer, at least one water-soluble polymer selected from the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, and polyalkylene glycols endcapped at one or both ends with alkyl, carboxyl or amino groups
and
(b) (i) homo- and copolymers of anionic monomers,
(ii) copolymers of anionic and cationic and, optionally, neutral monomers, the proportion of the anionic monomers incorporated in a form of polymerized units being greater than that of the cationic monomers, and
(iii) copolymers of at least one anionic monomer and at least one monomer selected from the group consisting of esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate.

12. The method of claim 16 wherein the neutralizing agent comprises at least one alkali metal, alkaline earth metal, or ammonium base.

13. The method of claim 16 wherein the neutralizing agent comprises sodium hydroxide solution, potassium hydroxide solution, ammonia, ethanolamine, diethanolamine, or triethanolamine.

14. The method of claim 16 wherein the aqueous extinguishing agent additionally comprises at least one flameproofing agent, one dye, one wetting agent, or mixtures thereof.

15. The method of claim 16 wherein the aqueous dispersion of water-soluble and/or water-swellable anionic polymer and the at least one water-soluble neutralizing agent are mixed continuously with water such that the mixture has a polymer content of not more than 5% by weight and a pH of at least 5.5 and a viscosity of more than 100 000 mPa·s (Brookfield viscometer, spindle V40203T01, 20 rpm, 23° C.).

16. A method of fighting a fire with an aqueous extinguishing agent comprising at least one polymer, wherein an aqueous dispersion of a water-soluble and/or a water-swellable anionic polymer and at least one water-soluble neutralizing agent are mixed in, either batchwise or continuously, with water to form the extinguishing agent having a polymer content of not more than 5% by weight and a pH of at least 5.5, and the extinguishing agent is used immediately for fire fighting.
